(19) United States
(12) Patent Application Publication
(10) Pub. No.: US 2019/0127000 A1
(43) Pub. Date: May 2, 2019

(54) Production Plant And Production Method

(71) Applicant: KUKA Systems GmbH, Augsburg (DE)

(72) Inventor: Martin Eberl, Augsburg (DE)

(21) Appl. No.: 16/095,510

(22) PCT Filed: Apr. 20, 2017
(86) PCT No.: PCT/EP2017/059339

§ 371 Date: Oct. 22, 2018

(30) Foreign Application Priority Data
Apr. 22, 2016 (DE) 20 2016 102 149.9

(51) Int. Cl. B62D 65/02; G01B 11/24; G01N 21/84

(52) U.S. Cl. CPC B62D 65/022; G01N 21/84; G01B 11/24

(57) ABSTRACT

A production plant and a production method for processing workpieces, in particular vehicle body components, wherein the production plant includes a preparation region and a production region for the workpieces and a conveying device for transporting the workpieces from the preparation region to the production region. The preparation region includes a loading region for loading the conveying device with workpieces. The transported workpieces are inspected in an inspection station which is arranged between the preparation region—in particular, the loading region—and the production region.

### CROSS-REFERENCE TO RELATED APPLICATIONS

This application is a national phase application under 35 U.S.C. § 371 of International Patent Application No. PCT/EP2017/059339, filed Apr. 20, 2017 (pending), which claims the benefit of priority to German Patent Application No. DE 20 2016 102 149.9, filed Apr. 22, 2016, the disclosures of which are incorporated by reference herein in their entirety.

### TECHNICAL FIELD

The invention relates to a production plant and a production method for processing workpieces.

### BACKGROUND

The practice of furnishing workpieces in a preparation region and transporting them by means of a conveying device to a production area, wherein the type and position of the workpiece is verified at a workstation in the production region before the production process is carried out, is known.

It is an object of the present invention to provide improved production technology.

### SUMMARY

The invention solves this problem with a production plant and a production method as shown and described herein.

The claimed production technology—that is, the production plant and the production method—have several advantages.

The arrangement of an inspection station for the transported workpieces between the preparation region—in particular, the loading region thereof—and the production region, and the local implementation of a workpiece inspection have the advantage that the production region can be freed from inspection tasks, and the available cycle time can be better utilized for the production processes. The inspection configuration can be separated from the production region, and optionally distanced from the same. According to one aspect of the invention, the workpiece can be inspected before the workpieces arrive in the production region. In addition, all workpieces coming from the preparation region or the loading region can be inspected in a central location in one or more inspection stations.

The preparation region—in particular, its loading region—and the production region can be spatially separated. In addition, there may be a functional separation.

The production plant can function with only one—or several—inspection stations. The inspection station can have a particularly high-quality inspection device for this purpose, which is expedient for the quality and speed of the inspection.

In particular, the inspection of the workpieces can occur during their transport and movement through the inspection station. The speed and performance of the inspection station can be optimized. A high inspection capacity in turn allows a reduction in the number and arrangement of the required inspection stations.

There are particular advantages for a production plant which comprises a conveying device comprising a plurality of conveying means, each having a load handling means for handling a plurality of identical or different workpieces in a defined manner. These workpieces may particularly be vehicle body components. The workpieces can be identical or similar, and can differ in their type. This is especially advantageous for a production plant for vehicle bodies in which different body types are produced in a preferably variable mix. The difference in type can pertain to various aspects: for example, differences in body shape (2- or 4-door, convertible, sedan, etc.), in how the part is matched to engine sizes, and in vehicle weight or the like.

The inspection configuration—that is, the inspection station and inspection procedure—can be intended and designed to inspect the type, the position and orientation, and the completeness (abbreviated TPC) of the transported workpieces on the load handling means. This is particularly advantageous if a plurality of identical or different workpieces are handled and transported on the load handling means. The workpieces may have been previously picked in the preparation region.

The inspection configuration can function to ensure that only workpieces with the correct TPC configuration are brought into the production region—in particular, a production station in the same. In addition, the production region can be informed accordingly. The supply of a TPC configuration—in particular, on a conveying means with a load handling means—reduces the risk of disruption in the production region. The result is cost savings and reductions in disruptions resulting from a potential omission of a TPC control in the production region—particularly in a production station. This omission is also expedient for a more flexible production region—in particular, the production stations. In addition, the workpiece inspection and TPC control can be carried out in the inspection station, removed from the production region, in the absence of obstacles. The inspection station can be universally designed, and enables the inspection of highly varying workpieces. This enables greater flexibility and variation of the workpieces processed in the production plant, as well as cost savings. Furthermore, new workpieces—and in particular, body and component types—can be quickly integrated into the production plant and the production method. The start-up times and costs can be reduced—particularly by an offline programming of the inspection station as well.

The load handling means can be adapted to each workpiece of a flexible type. In addition, it is expedient if each of the load handling means is arranged detachably on the conveying means. The conveying means can be universally designed, and can be equipped as needed with a load handling means. This can be done in the preparation region. In the preparation region, the load handling means can also be loaded with the workpieces. The inspection configuration is preferably arranged directly after the preparation region. The preparation station can be located in a prespecified conveying path for the conveying means.

The inspection configuration comprises a detection and capture configuration—in particular, an accordingly suitable sensor system—for the TPC inspection. The type of a workpiece can be detected, for example, via the shape and size thereof. During the inspection, the results of the capture of the actual type and/or shape, position and orientation, and completeness of the transported workpieces are evaluated in the inspection station or externally, and communicated—in particular, communicated to the production region. The production process can be performed quickly and safely based on this information. In particular, a process adaptation and possibly retrofitting for the incoming workpieces can be undertaken in the production region.

The communication can be carried out in different ways—for example, via data carriers on the conveying means and/or on the load handling means which contain the inspection result. Alternatively, or additionally, communication can take place via other data transmission paths—for example, wired or wirelessly. The inspection station communication in this case may occur with a system controller, and from there to the production region—particularly the relevant production stations. Alternatively, a direct communication is possible between the inspection station and the production region and/or the relevant production stations.

In the dependent claims, further advantageous embodiments of the invention are given.

The claimed production technology can also have the following features in any combination, in addition to the claims.

The load handling means of conveying means of the conveying device can be adapted to the specific, type-variable workpieces.

The load handling means can be arranged detachably on conveying means of the conveying device.

Individually controllable conveying means can travel on freely programmable conveying paths in a network of conveying paths of the conveying device.

The inspection device of an inspection station of the production plant can be connected to a system controller, and can transmit to the latter the inspection results and/or the actual values of the workpieces captured during the inspection.

The inspection device of an inspection station may include a detection device for the existence and shape—in particular, the height contour—of the workpieces.

A position sensor can be arranged on a load handling means. The position sensor can be read by the detection device. It can be designed and arranged to be readable for this purpose.

The loading region of a preparation region of the production plant can have a loading device for loading the conveying device—in particular, the load handling means—with picked workpieces. A preparation region of the production plant can have a storage for conveying means and a storage for load handling means.

Production stations of the production plant may be arranged in islands, and particularly in a matrix. The production stations can be surrounded by conveying paths.

Production stations of the production plant may have an inner workstation with production devices and a station controller with multiple type-specific control programs.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a schematic view of an exemplary production plant with a preparation region and a production region, as well as an inspection station, and

FIGS. 2 and 3 illustrate an exemplary inspection station in side view and plan view.

### DETAILED DESCRIPTION

The invention relates to a production plant (1) for workpieces (9, 10, 11), and an associated production method. The invention further relates to an inspection station (6) and an inspection method for the workpieces (9, 10, 11).

The workpieces (9, 10, 11) can be of any type and size. They can be single pieces or multiple pieces. Preferably, they are body components of vehicle bodies. The production plant (1) can be used, for example, for the body shells of vehicle bodies.

The workpieces (9, 10, 11) may be the same or different. The differences can be fundamental—for example, in type and size. On the other hand, there can be gradual differences, such as type differences, especially for body components. In this case, several workpieces (9, 10, 11) are similar to each other, wherein they constitute side walls of a vehicle body, for example, and differ with respect to the vehicle type—i.e, sedan with two or four doors, convertible, camper van, etc.

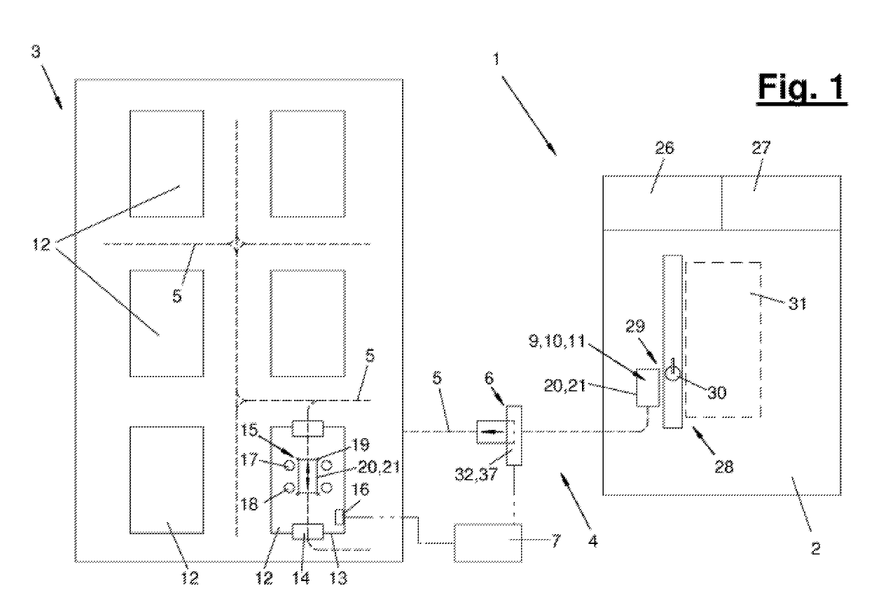

The production plant (1) is automated. It comprises, according to FIG. 1, a preparation region (2) for the workpieces (9, 10, 11) and a production region (3), as well as a conveying device (4). The production plant (1) may further include a plant controller (7) and possibly other components. In the production plant (1), an automatic production method is performed.

The production region (3) comprises one or more production stations (12), one of which is shown in more detail with its components, by way of example. As part of the automatic production method, one or more workpieces (9, 10, 11) can be processed in a sequence of production steps with different production processes. The production steps are carried out, for example, successively in a plurality of production stations (12), with a corresponding intermediate transport of the workpieces (9, 10, 11). Alternatively, the production steps can take place in a single production station (12).

These production methods may involve different techniques, such as joining—in particular, welding, soldering or gluing—application and removal of materials, heat treatments, forming, machining, assembling and installation operations or the like. In addition, the production processes may be used for the same or different workpieces (9, 10, 11)—particularly workpiece types. The initially separate workpieces (9, 10, 11) can be joined to form one or more assemblies.

The conveying device (4) comprises a plurality of conveying means (20) and a network of conveying paths (5) on which the conveying means (20) travel. The conveying means (20) are individually controllable and move in the conveying path network on freely programmable conveyance tracks. The conveying means (20) can be designed in any suitable manner. Preferably, they are designed as autonomous, floor-bound, driverless transport vehicles (AGVs).

The conveying means (20) each carry a load handling means (21) which is designed to handle one or more workpieces (9, 10, 11) in a defined manner. Preferably, a plurality of identical or different, particularly type-flexible, workpieces (9, 10, 11) are handled in a defined manner. Handling in a defined manner means that the number and identity, as well as the arrangement and the position and/or orientation of the workpieces (9, 10, 11) are prespecified on the load handling means (21). This concept can be subsumed under the terms type, position and orientation, and completeness (TPC).

The load handling means (21) can be arranged detachably on the respective conveying means (20). They can be removed and changed as needed. The load handling means (21) in this case have a defined, secured and reproducible arrangement on the respective conveying means (20). The load handling means (21) can be adapted to the respective type-flexible workpieces (9, 10, 11). They are equipped in the preparation region (2) with the respective, prespecified workpieces (9, 10, 11).

The preparation region (2) comprises a picking region (28) with a storage region (31) for the workpieces (9, 10, 11), and a loading region (29) for loading/equipping the load handling means (21) with the workpieces (9, 10, 11). The picking and loading and/or equipping can be fully automatic. A programmable loading device (30) can be arranged in the loading region (29) for this purpose. It can have, for example, one or more loading robots, which are optionally equipped with an additional axis—in particular, a linear driving axis. Conveying paths (5) lead into the preparation region (2) and out of the same.

The conveying means (20) can be stored in a storage (26) and the load handling means (27) can be stored in a further storage (27). The storages (26, 27) can be arranged in the preparation region (2) or in another suitable location. Furthermore, there is a changing device which is used to configure the preferably-universally-designed conveying means (20) as needed with the respective, required and preferably adapted load handling means (21), and to carry out a change if necessary.

An inspection station (6) for the workpieces (9, 10, 11) transported and picked by the conveying device (4) is arranged between the preparation region (2)—in particular, the loading region (29)—and the production region (3). In the inspection station (6), an inspection method is carried out in which, in particular, the type, position and orientation, and completeness of the transported workpieces (9, 10, 11) on the conveying device (4)—particularly on the load handling means (21)—are inspected. The inspection station (6) is provided and technically designed for this purpose.

The workpiece inspection can be carried out centrally, after picking and loading/equipping, and before entry of the workpieces (9, 10, 11) into the production region (3). If the inspection result is positive, the workpieces (9, 10, 11) can be transported further into the production region (3). In the event of a negative inspection result, they can be transported back to the preparation region (2) for troubleshooting purposes.

The inspection station (6) is located in or on a conveying path (5). The inspection can be carried out during the transport of the workpieces (9, 10, 11) through the inspection station (6), in particular during the passage of a transport means (20) through the station (6). The inspection station (6) accordingly offers such passage.

The inspection station (6) comprises an inspection device (32) and an inspection method carried out by the same, to capture the actual shape, position and orientation, and completeness of the transported and picked workpieces (9, 10, 11) on the load handling means (21). Furthermore, the captured, actual values can be evaluated. In addition, it is also possible to communicate the actual values and/or the evaluation/inspection results within the production plant (1). The inspection device (32) can, for example, compare the captured, actual values to a desired target specification, and communicate the inspection result obtained therefrom. Alternatively, or additionally, it is possible to transmit the captured, actual values to an external comparison device—for example, to the system controller (7)—where the comparison is carried out and the inspection result is compiled.

The communication for the determination of the actual values and/or the evaluation/inspection results can take place in different ways. It can be performed, for example, by wired and/or wireless remote data transmission.

Alternatively, or additionally, one or more data carriers (8) can be arranged on the conveying means (20) and/or on the load handling means (21). These data carriers (8) can be read and/or written by the inspection station (6) and/or the inspection device (32). For this purpose, the inspection device (32) comprises, for example, a correspondingly suitable reading device and/or writing device for reading and/or writing to the data carriers (8). The data carriers (8) can be designed, for example, as noncontact readable and writable units—in particular, transponders or RFID tags. Alternatively, any other configurations are possible.

The inspection results can be communicated to the production region (3), in particular to each of the production stations (12) provided for carrying out the workpiece-specific production steps. This communication may be made directly by the inspection station (6) to the production region (3), in particular to the respective production stations (12). On the other hand, an indirect communication is possible—for example, via the system controller (7). The inspection station (6)—in particular, the inspection device (32)—is connected to the system controller (7). It can transmit the inspection results and/or the captured, actual values for TPC of the workpieces to the latter via a suitable communication.

The inspection device (32) comprises a detection device (34) for the workpieces (9, 10, 11). By means of the same, the existence and shape of the workpieces (9, 10, 11) can be detected. In particular, a height contour of the workpieces (9, 10, 11) can be detected by means of the detection device (34). The detection can take place during the movement of the workpieces (9, 10, 11).

The inspection device (32) further comprises a capture device (35) for the position of the workpieces (9, 10, 11). In this case, in particular, the position of the workpieces (9, 10, 11) on the load handling means (21) can be captured. The position capture may be direct or indirect. On the one hand the inspection device (32) can particularly determine, from the existence and shape, the height contour of the workpieces (9, 10); on the other hand, it can determine, from the workpiece position, said actual values for TPC.

The inspection device (32) and its devices (34, 35) may have any suitable technical design. The detection device (34) comprises, for example, a preferably non-contact sensor system which provides an optical detection function, for example. Such a sensor system may be a single unit or multiple units. It can, for example, comprise a laser stripe sensor and/or a beam scanner, particularly a laser scanner, and/or a linescan camera or the like.

The detection device (34) preferably detects, from above and transversely to the transport direction (38), all workpieces (9, 10, 11) on the conveying device (4) underneath—in particular, on the load handling means (21). For this purpose, the detection device (34) and its sensor system are arranged on a preferably portal-like frame (37) of the inspection station (6). The inspection point and/or detection point (33) is preferably located in the frame region and below the detection device (34). The inspection device (32) and the frame (37) are located on a conveying path (5), wherein the conveying means (20) with the workpieces to be inspected (9, 10, 11) travels past the frame (37) or under the same. The inspection in this case takes place during the movement in the transport direction (38).

The frame (37) may be stationary or dynamic. A dynamic frame can be moved during the inspection with the conveying means (20) in the transport direction (38), or in the opposite direction, for example. The detection process can advantageously be influenced—in particular, accelerated—by a corresponding movement coordination of the conveying means (20) and the inspection device (32). In addition, it is possible to avoid shadow zones in the detection and, if necessary, to detect the workpieces (9, 10, 11) from different directions of approach or viewing directions.

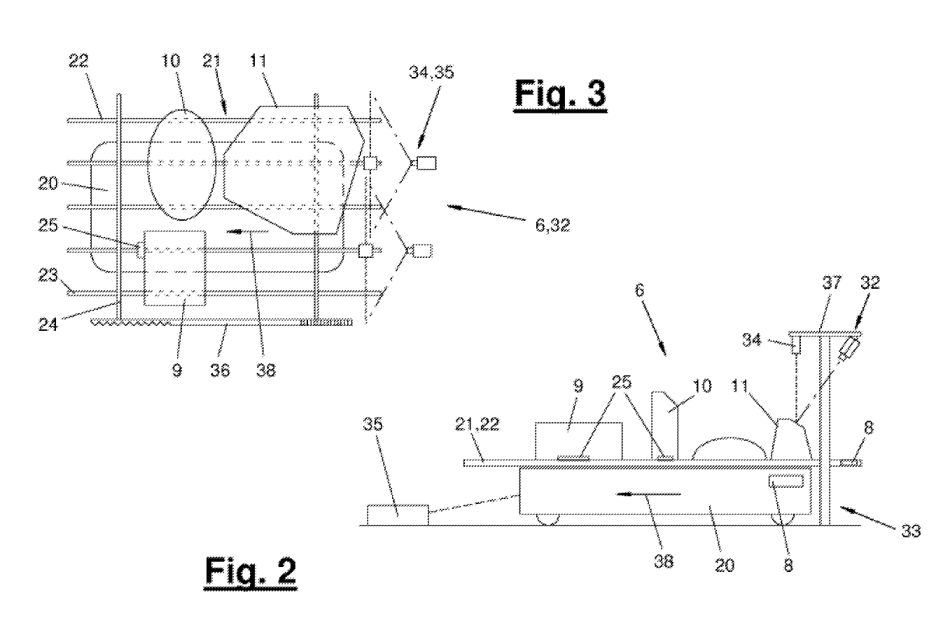

For the position capture of the workpieces (9, 10, 11), the capture device (35) can—for example, according to FIG. 2—be arranged as a stationary component, and capture the movement and/or change in position of the conveying means (20) and/or the load handling means (21) in the transport direction (38). The variable position values can be linked to the values captured by the detection device (34)—for example, the height contour of the workpieces (9, 10, 11). From this, a point cloud can be formed, from which said TPC of the workpieces (9, 10, 11) can be determined.

During evaluation and inspection, the data of the captured point cloud is compared inside a 3D image processing system to the target geometries and workpiece positions that are available from the design, and the TPC-compliant workpiece configuration is verified. If the TPC configuration is correct, the conveying means (20) can continue movement with the inspected workpieces (9, 10, 11) into the production region (3) and into the production station (12) provided in the production process. In the case of a negative inspection result, the workpieces (9, 10, 11) are rejected and must be reworked, or the picking must be changed. For this purpose, the conveying means (20) returns on a corresponding conveying path (5) to the preparation region (2).

FIG. 3 shows another possibility for the position capture. In this case, a position encoder (36) is arranged on the load handling means (21). The position encoder (36) can be read by the detection device (34) during said detection of the workpieces (9, 10, 11), and is designed and arranged accordingly. The position encoder (36) preferably runs in the transport direction (38), and extends over the entire length of the arrangement region of the workpieces (9, 10, 11). It can form a reference bar. The position encoder (36) is designed, for example, as a scale, toothed rack, or in another way. It comprises a defined position with respect to the load handling means (21). In this way, a positional relationship between the load handling means (21) and the detected workpieces (9, 10, 11), in particular their height contour, can be established.

With both of the above-described techniques for position capture, in connection with the detection device (31), it is possible to precisely determine the identity and/or the type, the position and orientation, and the completeness of the workpieces (9, 10, 11) with respect to the load handling means (21). This inspection result can be communicated in the aforementioned manner.

FIGS. 2 and 3 also illustrate a preferred design of the load handling means (21). This comprises, for example, a handling frame (22) which can be detachably mounted on the conveying means (20) in a defined position, and which comprises, at a defined and preferably variable position, one or more universal, preferably adaptable, workpiece holders (25) for the workpieces (9, 10, 11). The handling frame (22) can have a filigree and skeletal form for weight optimization. It consists, for example, of several longitudinally- and transversely-oriented, spaced rods (23, 24), which are fixed to each other in a suitable and defined manner. The rods (23, 24) may be designed, for example, as perforated round or prismatic columns, wherein the position-defined perforation enables defined connection points with suitable connecting means between the rods (23, 24). The longitudinal rods (23) may be aligned along the longitudinal axis of the conveying means (20) and/or along the transport direction (38). The transverse rods (24) can hold, in a defined manner, for example, on the outer edge of the handling frame (22), one or more position encoders (36)—particularly reference bars.

According to FIG. 1, in the preferred embodiment, the production stations (12) are arranged in the production region (3) in the manner of islands at a mutual distance from each other. For example, this arrangement can be in a matrix, particularly a regular matrix, forming rows and columns. The production stations (12) can be surrounded by conveying paths (5) in the manner of a network.

The production stations (12) can have the same design as each other. They can, for example, have an inner workstation (15) for carrying out the aforementioned production steps. The conveying means (20) can travel with the load handling means (21) and the workpieces (9, 10, 11) arranged thereon on a conveying path (5) into the production station (12) and to the workstation (15). After completion of the production steps, they can travel back on the same path or travel in the other direction—in particular, in continuation of their entry direction—through the production station (12), and can leave it again.

The production station (12) comprises a protective partition (13) which encloses the station region laterally and which comprises one or more locks (14). The protective partition (13) prevents the uncontrolled access of persons into the station interior. It can have monitored personnel access points. The lock(s) (14) can be closed, and serve to allow entrance and/or exit of the conveying means (20).

The production steps are carried out in the workstation (15). For this purpose, production devices (17, 18) and a positioning device (19) are arranged in the workstation (15). The production devices (17, 18) can be program-controlled. They may be designed particularly as industrial robots, in particular as handling robots (17) and processing robots (18)—such as joining robots. They can be controlled by the station controller (16) and configured with adapted programs which are matched to the respective type-flexible workpieces (9, 10, 11) to be machined.

The production station (12) can be designed as a single production cell with only one workstation (15) together with production devices (17, 18) and the positioning device (19). Alternatively, a multi-cell design with several adjacent sub-cells is possible, each having a workstation (15) with production devices (17, 18) and a positioning device (19).

The information about the TPC of said workpieces (9, 10, 11) may be obtained by the station controller (16) via said communication and/or via a suitable reading device for reading one or more data carriers (8). The reading device can be arranged in the production station (12) or upstream of the same. Furthermore, a writing device may be included, which rewrites the corresponding process and identity information to the data carrier(s) (8) after completion of the production steps. In addition to the TPC information, the data carriers (8) can also contain information about the production state and/or production progress of the workpieces (9, 10, 11), about the next production station (12) in the travel path, or the like. The station controller (16) also communicates with the system controller (7). From the same, it can receive information about the incoming workpieces (9, 10, 11) to be machined and, conversely, provide feedback on the completion of the production steps, quality inspection results, or the like.

The positioning device (19) can serve different purposes. On the one hand, it can receive the load handling means (21), if necessary separate it from the conveying means (20), and hold it in a prespecified, defined position for the processing to be carried out by the production devices (17, 18). The positioning device (19) can be arranged, for example, on a stationary frame.

In addition, the positioning device (19) may have a workpiece placement area which is arranged in the workstation (15) at a distance above the conveying path (5) for the transport means (20). A production device (17) can hold the workpieces (9, 10, 11) in a floating position for processing by the production device(s) (18), or deposit them temporarily in said workpiece placement area. The conveying means (20) freed of the workpieces (9, 10, 11), with the load handling means (21), can be loaded again after the production steps are carried out with the—for example, joined—workpieces (9, 10, 11). Alternatively, the conveying means (20) with the empty load handling means (21) can leave the production station (12), wherein subsequently another conveying means (20) with a possibly different load handling means (21) enters and receives the processed workpieces (9, 10, 11). If necessary, one or more further workpieces can be supplied with this new load handling means (21).

In the production station (12), if necessary, further workpieces can be supplied from a supply inside the station, or from the outside. Preferably, only the picked workpieces (9, 10, 11) are supplied on one or more load handling means (21). Furthermore, the production devices (17, 18) can be adapted by changeable tools to the respective, different workpieces (9, 10, 11), and to different production steps. For this purpose, one or more tool stores can be present in the production station (12). In addition, further station components, such as power supplies, operating material for fluids, such as coolant, adhesives, lacquers or the like, can be available.

The preparation region (2) can end at the loading region (29). The single or multiple inspection stations (6) can be arranged directly after the loading region (29). It can also be more distant. The workpiece inspection is carried out in a place and at a time before the workpiece (9, 10, 11) arrives in the production region (3). The preparation region (2)—in particular, its loading region (29)—and the production region (3) are spatially separated from each other. There is also a functional separation. The production region (3), and optionally the preparation region (2), can be surrounded by a boundary, in particular a protective partition.

Variations of the embodiments shown and described are possible in various ways. In particular, the features of the above-described embodiments and the named variants can be combined with one another—and in particular, exchanged. Constructional modifications are possible with regard to the inspection station (6) and its components, in particular the inspection device (32), the frame (37), etc. The workpiece detection and position capture can be performed in other ways—such as in a stationary manner and by a camera system.

### LIST OF REFERENCE NUMBERS

1. production plant
2. preparation region
3. production region
4. conveying device
5. conveying path
6. inspection station
7. system controller
8. data carrier
9. workpiece, body component
10. workpiece, body component
11. workpiece, body component
12. production station, production cell
13. protective partition
14. lock
15. workstation
16. station controller
17. production device, robot, handling robot
18. production device, robot, welding robot
19. positioning device, workpiece placement area
20. conveying means, AGV
21. load handling means LAM
22. handling rack
23. rod, longitudinal
24. rod, transverse
25. workpiece holder
26. storage for conveying means
27. storage for load handling means
28. picking region
29. loading region
30. loading device, loading robot
31. storage region
32. inspection device TPC
33. inspection station
34. detection device, workpieces
35. capture device, position
36. position encoder, reference bar
37. rack, portal
38. transport direction

What is claimed is:

1-20. (canceled)

21. A production plant for workpieces, comprising:
a preparation region and a production region for the workpieces;
a conveying device for transporting the workpieces from the preparation region to the production region;
wherein the preparation region comprises a loading region for the loading of the conveying device with workpieces; and
an inspection station for the transported workpieces, the inspection station arranged between the preparation region and the production region.

22. The production plant of claim 21, wherein the conveying device comprises a plurality of conveying means, each conveying means including a load handling means for handling a plurality of identical or different workpieces in a defined manner.

23. The production plant of claim 22, wherein the inspection station is configured to inspect the type, the position and orientation, and the completeness of the transported workpieces on the load handling means.

24. The production plant of claim 21, wherein the inspection station inspects the workpieces during their transport through the inspection station.

25. The production plant of claim 21, wherein the inspection station comprises an inspection device configured to capture values related to the actual shape, position and orientation, and completeness of the transported workpieces, and to evaluate the captured, actual values.

26. The production plant of claim 25, wherein the inspection device compares the captured, actual values to a target specification, or transmits the captured, actual values to an external comparison device.

27. The production plant of claim 22, wherein at least one of the conveying means or the load handling means comprise a data carrier with data related to the workpieces being handled.

28. The production plant of claim 27, wherein the inspection device comprises at least one of a reading device or a writing device operable with the data carrier.

29. The production plant of claim 25, wherein the inspection device comprises a detection device to detect the presence and shape of the workpieces.

30. The production plant of claim 29, wherein the detection device is at least one of:
configured to detect the height contour of the workpieces;
a contactless detection device;
an optical sensor system;
a laser stripe sensor;
a laser scanner; or
a linescan camera.

31. The production plant of claim 29, wherein the inspection device comprises a capture device configured to capture the position of the workpieces.

32. The production plant of claim 31, wherein at least one of the detection device or the capture device is arranged on a stationary or dynamic frame.

33. The production plant of claim 21, wherein the conveying device comprises a plurality of individually controllable conveying means and a network of conveying paths.

34. The production plant of claim 33, wherein the conveying means are configured as autonomous, floor-bound, driverless transport vehicles (AGVs).

35. The production plant of claim 21, wherein the preparation region and the production region are spatially separated from each other.

36. The production plant of claim 21, wherein the production region comprises a plurality of production stations for the workpieces.

37. The production plant of claim 36, wherein the production stations comprise a surrounding, protective partition with at least one lock for at least one of an entrance or an exit of a transport means.

38. A production method for workpieces in a production plant that includes a preparation region, a production region, and a conveying device for transporting the workpieces from the preparation region to the production region, wherein the preparation region comprises a loading region for the loading of the conveying device with workpieces, the method comprising:
inspecting the transported workpieces in an inspection station which is arranged between the preparation region and the production region.

39. The production method of claim 38, further comprising:
transporting each workpiece on conveying means using a load handling means that is configured to handle a plurality of identical or different workpieces in a defined manner.

40. The production method of claim 38, wherein inspecting the transported workpieces comprises:
inspecting the type, the position and orientation, and the completeness of the workpieces transported on a load handling means.

41. The production method of claim 40, wherein at least one of:
inspecting the type, the position and orientation, and the completeness of the workpieces is accomplished without contacting the workpieces;
inspecting the type, the position and orientation, and the completeness of the workpieces is accomplished optically; or
inspecting the type, the position and orientation, and the completeness of the workpieces is accomplished during their transport through the inspection station.
